(19) United States
(12) Patent Application Publication
(10) Pub. No.: US 2008/0037710 A1
(43) Pub. Date: Feb. 14, 2008

(54) Steerable Multistage Collimation for Radiographic Imaging

(76) Inventor: Anthony Davis, Los Alamos, NM (US)

Correspondence Address: GLENN L. WEBB;GLENN L. WEBB P.C., P.O BOX 951, CONIFER, CO, 80433, US

(21) Appl. No.: 11/747,193

(22) Filed: May 10, 2007

Related U.S. Application Data
(63) Continuation of application No. 11/464,480, filed on Aug. 14, 2006, now abandoned.
Application No. 11/464,480 is a continuation of application No. 11/277,611, filed on Mar. 27, 2006, now abandoned.
(60) Provisional application No. 60/594,308, filed on Mar. 28, 2005.

(51) Int. Cl. G21K 1/02

(52) U.S. Cl. 378/150

(57) ABSTRACT

A system for reducing scatter in radiographic imaging systems while permitting large area imaging. Multiple collimators are used to successively trim the radiation beam to match the detector plate while simultaneously eliminating scatter from the previous stages. The movable collimation stages, in conjunction with nonmoving scatter reduction stages, trim the beam to match the detector area. For larger part imaging, the detector may move. The present invention allows the collimators to move with the detector to steer the collimated beam onto only the active area of the detector.

### RELATED APPLICATIONS

This application is continuation of Ser. No. 11/464,480, filed on Aug. 14, 2006 which is a continuation of Ser. No. 11/277,611, filed on Mar. 27, 2006 which claims benefit of provisional application 60/594,308.

### FIELD OF THE INVENTION

This invention relates to the field of radiographic imaging and particularly to the field of reducing scatter in radiographic imaging.

### BACKGROUND OF THE INVENTION

One problem with radiographic imaging, such as computed tomography, X-rays and other types of radiation point systems is scatter. Scatter is defined as secondary radiation resulting from deflected radiation, from radiation generated from the object being imaged, radiation that travels along non-direct paths to the detector or other secondary radiation that is detected during the imaging process. Scatter detected by the detector during the imaging process negatively affects the resolution and sensitivity of the imaging system.

One attempt to solve this problem with scatter in radiographic imaging has been to use collimators to absorb indirect radiation and/or direct the radiation beam to the object being irradiated. Typically, a collimator will filter a stream of rays so that only beams traveling parallel to one another in a selected direction will pass through while all other beams are absorbed. A problem arises when large area imaging is conducted as the object being irradiated will reflect beams, give off radiation during the process, and/or reflect off the collimator itself.

Typical collimators are not able to adequately filter beams when used with large area imaging. Often, multiple stage collimators may be used for large area imaging to minimize the deflection from the collimators. This reduces the scatter from the radiation source. However, there still may be significant radiation emitting from the object being irradiated. This not only affects the resolution and sensitivity of the image but may also damage the detector as well. This is particularly a problem with large objects.

Thus a problem exists with the prior radiographic imaging systems particularly when large area imaging is performed.

### SUMMARY OF THE INVENTION

The present invention solves this and other problems by providing a movable multistage collimation system. Multiple collimators are used to successively trim the radiation beam to match the detector plate while simultaneously eliminating scatter from previous stages. This allows large area imagining with reduced scatter.

A preferred embodiment of the present invention uses a steerable beam that is produced by multiple moving collimator stages used with fixed collimation stages. The beam is reduced to cover only the active area of the detector in any position. This decreases the amount of scatter produced by the object being irradiated.

Another preferred embodiment of the present invention moves the movable collimator stages in horizontal and vertical directions. This further allows the beam to be focused on specific portions of the object being imaged to match the movement of the detector plate.

Another preferred embodiment includes a system for beam sizing collimators. This allows the system to adjust for detectors with active areas of differing sizes.

These and other features will be evident from the ensuing detailed description of preferred embodiments and from the drawings.

### BRIEF DESCRIPTION OF DRAWINGS

FIG. 1 illustrates a typical traditional multistage fixed collimator system.

FIG. 2 illustrates a preferred embodiment of a movable multistage collimation system of the present invention.

FIG. 3 illustrates another view of the embodiment of FIG. 2.

FIG. 4 illustrates another preferred embodiment of a movable multistage collimation system of the present invention.

### DETAILED DESCRIPTION OF PREFERRED EMBODIMENTS

The present invention provides systems and process for minimizing scatter in radiographic systems. Preferred embodiments of these systems and processes are discussed below. It is to be expressly understood that this descriptive embodiment is provided for explanatory purposes only and is not meant to limit the scope of the claimed invention. Other types and uses of the systems and processes are also considered to be within the scope of the present invention.

The present invention includes a novel method for reducing scatter in radiographic imaging systems while permitting large area imaging. Multiple collimators are used to successively trim the radiation beam to match the detector plate while simultaneously eliminating scatter from the previous stages. The movable collimation stages, in conjunction with nonmoving scatter reduction stages, trim the beam to match the detector area. For larger part imaging, the detector may move. The present invention allows the collimators to move with the detector to steer the collimated beam onto only the active area of the detector.

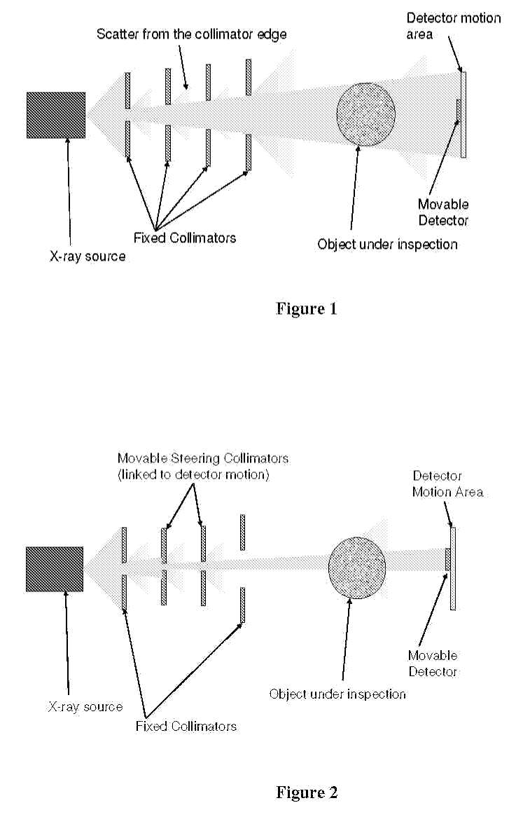

A typical fixed collimator setup is illustrated in FIG. 1. A series of collimators 10 are spaced from one another to successively trim the radiation beam to match the detector plate 20. The detector plate 20 often must be movable to accommodate the imaging of large objects. A radiation source 30 emits a radiation beam 32 that is filtered by the collimators 10. Each collimator trims the radiation beam to match the detector while eliminating the scatter from the previous states as shown in FIG. 1. The entire possible motion area for the detector is illuminated with X-rays 32. This requires a large beam in order to cover the entire motion detector area. This larger beam increases the amount of scatter produced by object as well as increasing the amount of scatter that may pass through the collimators.

This typical multistage collimation system reduces scatter. However, the scatter from the part under inspection is significant particularly with large area images. The detector shielding must be increased to protect detector electronics from the main beam with completely covers the detector. Also, the resolution and sensitivity of the system is reduced.

The present invention reduces the scatter by steering the beam to match movement of the detector plate. This minimizes the radiation from the object being irradiated by reducing the amount of the object being irradiated. Also, the system eliminates the scatter from the collimator stages.

A preferred embodiment of this system is illustrated in FIG. 2. The system provides a steerable beam 50 produced by multiple moving collimators stages 60 which can be used in conjunction with fixed collimation stages 70 to reduce scatter. The beam is reduced to cover only the active area of the detector in any position. This greatly decreases the amount of scatter produced by the object being irradiated. Additionally the amount of shielding required to protect the detector can be reduced.

The movable collimator stages 60 are operated by actuators or other movement systems that are linked to the movable detectors. These can be by any type of actuators, electronic, hydraulic, servomotors, etc. and control systems. As the detector plate is moved behind the object being imagined, the movable collimators 60 are also moved. The beam 50 emitted by the radiation source 52 is steered by the movement of the movable collimators in combination with the fixed collimators 70 to match the movement of the detector plate.

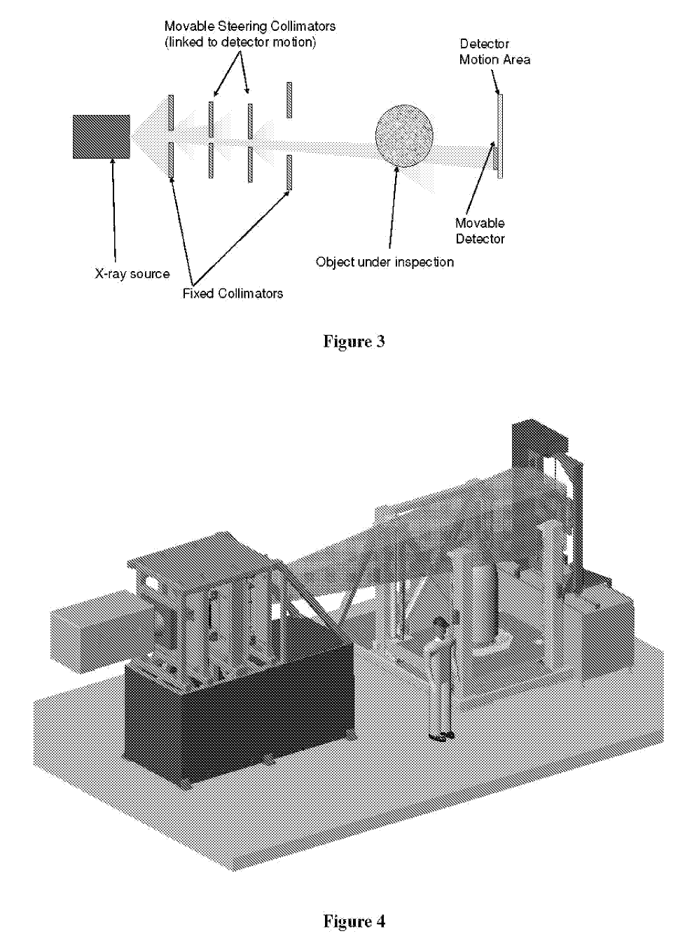

This movement of beam 50 is illustrated in FIG. 3. The motion is illustrated, showing how the moving collimators 60 track the detector to illuminate only the active area of the detector. This technique substantially reduces overall radiation in the area and improves image quality.

Another preferred embodiment of the present invention provides a system that moves the movable collimators not only in single direction but in two directions as well. The system of this embodiment applies this technique of steering the radiation beam in both horizontal and vertical directions. This further allows the beam to be focused on specific portions of the large object being imagined to match the movement of the detector plate. This greatly reduces the amount of radiation being deflected by the stages and by the object to reduce the amount of scatter to increase the image quality.

Another preferred embodiment of the present invention is illustrated in FIG. 4. This embodiment not only encompasses the above described movable collimators movable in horizontal and vertical directions in combination with the fixed collimators but also includes a system for beam sizing collimators. This allows the system to adjust for detectors with active areas of differing sizes. This system provides a great deal of control over the radiation beam path. Thus, the amount of scatter from the object being imaged can be reduced to improve the image quality. Also, the shielding of the detector can be reduced as well.

The above described embodiments are provided for descriptive purposes only and are not meant to limit the scope of the present invention. These and other embodiments are considered to be within the scope of the present invention.

1. A system for producing a radiographic image, said system comprises:
a radiation source;
a detector plate;
at least one fixed collimator; and
at least one movable collimator, wherein said at least one fixed collimator and said at least one movable collimator steer a beam produced by said radiation source to said detector plate.

2. The system of claim 1 wherein said system further includes:
a plurality of fixed collimators for steering said beam to said detector plate.

3. The system of claim 1 wherein said system further includes:
a plurality of movable collimators for steering said beam to said detector plate.

4. The system of claim 1 wherein said system further includes:
a plurality of fixed collimators; and
a plurality of movable collimators.

5. The system of claim 1 wherein said system further includes:
a mechanism for moving said detector plate for creating images of large objects.

6. The system of claim 1 wherein said system further includes:
a mechanism for moving said detector plate for creating images of large objects; and
a mechanism for moving said at least one movable collimator linked to the movement of said detector plate.

7. The system of claim 1 wherein said system further includes:
a mechanism for moving said detector plate in horizontal and vertical directions for creating images of large objects; and
a mechanism for moving said at least one movable collimator in horizontal and vertical directions and linked to the movement of said detector plate.

8. The system of claim 1 wherein said system further includes:
a mechanism for moving said at least one movable collimator to steer said beam to different areas on said detector plate.

9. The system of claim 1 wherein said system further includes:
a mechanism for moving said at least one movable collimator in horizontal and vertical directions to steer said beam to different areas on said detector plate.

10. The system of claim 1 wherein said system further includes:
a mechanism for moving said at least one movable collimator for changing the size of said beam on said detector plate.

11. The system of claim 1 wherein said system further includes:
a mechanism for moving said detector plate for creating images of large objects; and
a mechanism for moving said at least one movable collimator linked to the movement of said detector plate for creating images of large objects and for changing the size of said beam on said detector plate.

12. The system of claim 1 wherein said system further includes:
a mechanism for moving said detector plate in horizontal and vertical directions for creating images of large objects; and
a mechanism for moving said at least one movable collimator in horizontal and vertical directions and linked to the movement of said detector plate for creating images of large objects and for changing the size of said beam on said detector plate.

13. A system for producing a radiographic image, said system comprises:
a radiation source;
a detector plate;
a mechanism for moving said detector plate;
at least one fixed collimator;
at least one movable collimator; and
a mechanism for moving said at least one movable collimator and linked to the movement of said movable detector plate, wherein said at least one fixed collimator and said at least one movable collimator steer a beam produced by said radiation source to said detector plate.

14. The system of claim 13 wherein said system further includes:
a plurality of fixed collimators for steering said beam to said detector plate.

15. The system of claim 13 wherein said system further includes:
a plurality of movable collimators for steering said beam to said detector plate.

16. The system of claim 13 wherein said system further includes:
a plurality of fixed collimators; and
a plurality of movable collimators.

17. The system of claim 13 wherein said system further includes:
a mechanism for moving said detector plate in horizontal and vertical directions for creating images of large objects; and
a mechanism for moving said at least one movable collimator in horizontal and vertical directions and linked to the movement of said detector plate.

18. The system of claim 13 wherein said system further includes:
a mechanism for moving said at least one movable collimator to steer said beam to different areas on said detector plate.

19. The system of claim 13 wherein said system further includes:
a mechanism for moving said at least one movable collimator for changing the size of said beam on said detector plate.
